(19) United States
(12) Patent Application Publication
(10) Pub. No.: US 2012/0024667 A1
(43) Pub. Date: Feb. 2, 2012

(54) ADJUSTABLE SYSTEM FOR TRANSFERRING AND ACCUMULATING PHARMACEUTICAL DEVICES

(75) Inventors: Christian Gasperini, Bologna (IT); Prabhakar Umesh Karmarkar, Maharashtra (IN)

(73) Assignee: IMA-PG India Limited, Navi Mumbai (IN)

(21) Appl. No.: 13/127,903

(22) PCT Filed: Nov. 4, 2009
(86) PCT No.: PCT/IN2009/000623

§ 371 Date: Aug. 19, 2011

(30) Foreign Application Priority Data
Nov. 6, 2008 (IN) 2362/MUM/2008

(51) Int. Cl. B65G 15/60; B65G 15/20

(52) U.S. Cl. 198/586

(57) ABSTRACT

A guiding and transferring device (4) for guiding and transferring pharmaceutical devices comprises a frame (7); a plurality of conveyor devices (10) defining a longitudinal direction; a guide device (8) supported on the frame (7) and adapted to guide the conveyor devices along a transversal direction perpendicular to the longitudinal direction; the guiding and transferring device (4) further comprising an adjustment device (9) coupled to the conveyor devices (10) and adapted to adjust a gap between two adjacent conveyor devices (10) along the transversal direction.

### FIELD OF INVENTION

The present invention relates to an adjustable system for transferring and accumulating pharmaceutical/medical devices, in particular syringes.

### BACKGROUND OF THE INVENTION

There are known in the art packaging systems for packaging pre-filled syringes into suitable containers, for example blister packages.

Generally, such systems comprise a plurality of stations where the syringes are sterilised, filled with one or more pharmaceutical products in liquid and/or solid form in one or more filling stations and finally packaged in blister packages. The syringes are transferred from one station to the subsequent one by means of guiding and transferring devices, which comprise a plurality of parallel belts forming a track with rails at a predetermined mutual distance, or gap, for supporting a flange or lugs of the syringes.

In case of failure of one or more of the stations, it is known in the art to arrange the guiding and transferring devices in shape of a serpentine, with bend and rectilinear parts, in order to provide for a accumulation/buffer of syringes for a subsequent station and preventing the stop of the packaging system.

The known guiding and transferring devices are dedicated components of the system, that are able to process one type of syringes only, depending on the syringe dimensions, in particular the transversal dimensions of the flange.

In fact, as the gap between the rails of the known guiding and transferring devices is fixed, too small syringes would not be supported by the belts, while too large syringes would get stuck between the belts.

In practice, where the syringes to be packaged change in dimension and/or shape, the known guiding and transferring devices have to be replaced with suitable ones.

Of course, replacement procedures are costly and time-consuming.

### DISCLOSURE OF THE INVENTION

The present invention overcomes the above disadvantages and provides for an adjustable guiding and transferring device for transferring and buffering/accumulating pharmaceutical devices, in particular syringes.

The guiding and transferring device according to the invention comprises a plurality of conveyor devices, in particular belt units with parallel belts, each belt having edges for supporting syringes, the belt units being connected to an adjusting device adapted to adjust a gap between the belts of two adjacent belt units.

In one preferred embodiment, the guiding and transferring device comprises an adjusting device with a single lead screw arrangement adapted to simultaneously adjust the gap between all of the belts.

### BRIEF DESCRIPTION OF THE DRAWINGS

The invention will now be described with reference to the drawings, given by way of non limiting examples only, wherein:

FIG. 1 is a top view of a guiding and transferring system with a guiding and transferring device according to the invention

FIG. 2 is an exploded view of the guiding and transferring device of FIG. 1;

FIG. 3 is a perspective view of the guiding and transferring device of FIG. 1, with some components omitted for the sake of clarity;

FIG. 4 is an exploded view of a belt unit of the guiding and transferring device of FIG. 1, with some components omitted for the sake of clarity; and

FIG. 5 is a perspective view of an adjusting device of the guiding and transferring device of FIG. 1.

### DETAILED DESCRIPTION OF THE INVENTION

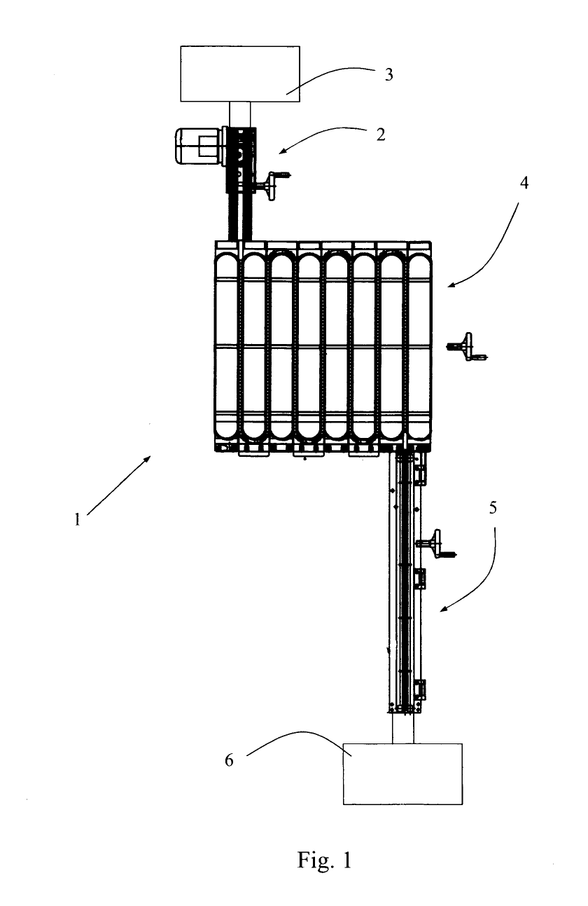

With reference to FIG. 1, a guiding and transferring system 1 for a packaging system for packaging pre-filled syringes into suitable containers, for example blister packages, comprises an entry adjustable link up conveyor 2 that connects a first station 3, for example a filling station, and a guiding and transferring device 4. The guiding and transferring system 1 further comprises an exit adjustable link up conveyor 5 connecting the guiding and transferring device 4 and a second station 6, for example a packaging station of the same packaging system.

The entry adjustable link up conveyor 2, the exit adjustable link up conveyor 5 and the stations 3, 6 of the packaging system are of a known type and thus will not be described in details for the sake of simplicity.

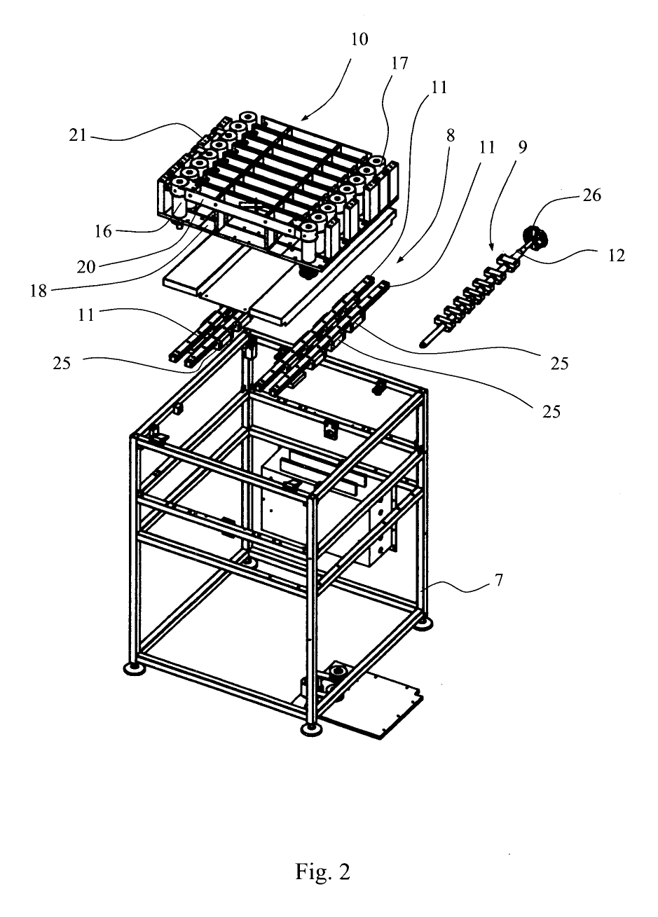

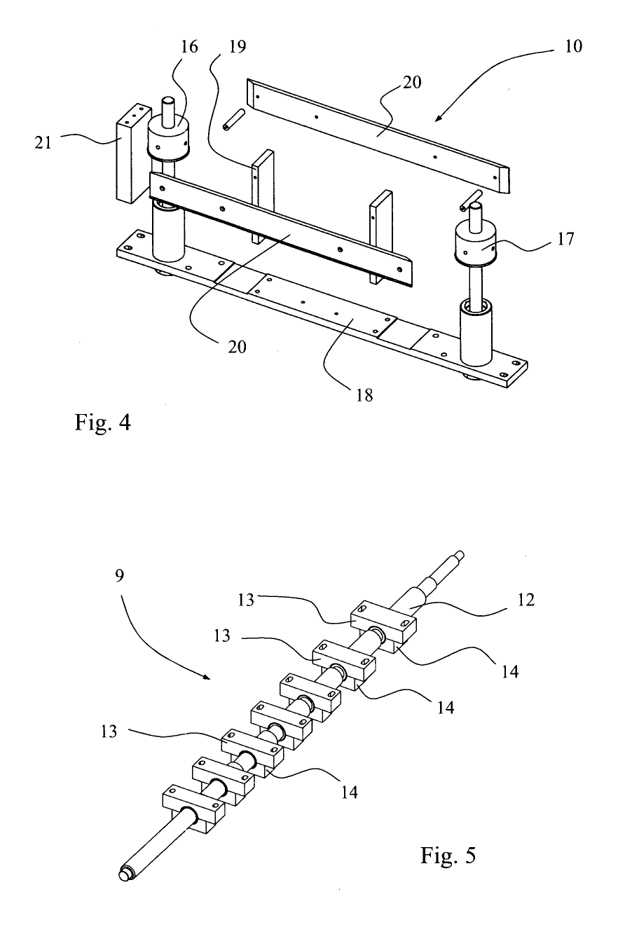

With reference to FIGS. 2-5, the guiding and transferring device 4 comprises a frame 7, on which there are mounted a guide device 8 and an adjustment device 9. In the specific embodiment of the figures, the guide device 8 comprises four guide rails 11 which define a transversal direction, with a plurality of blocks 25 movable along the guide rails 11 and connected to a plurality of belt units 10. The adjustment device 9 comprises a lead screw 12 (visible in FIG. 5) with variable pitch arranged along the transversal direction and coupled to a plurality of pairs of upper 13 and lower 14 nuts. Each upper nut 13 is connected to one belt unit 10.

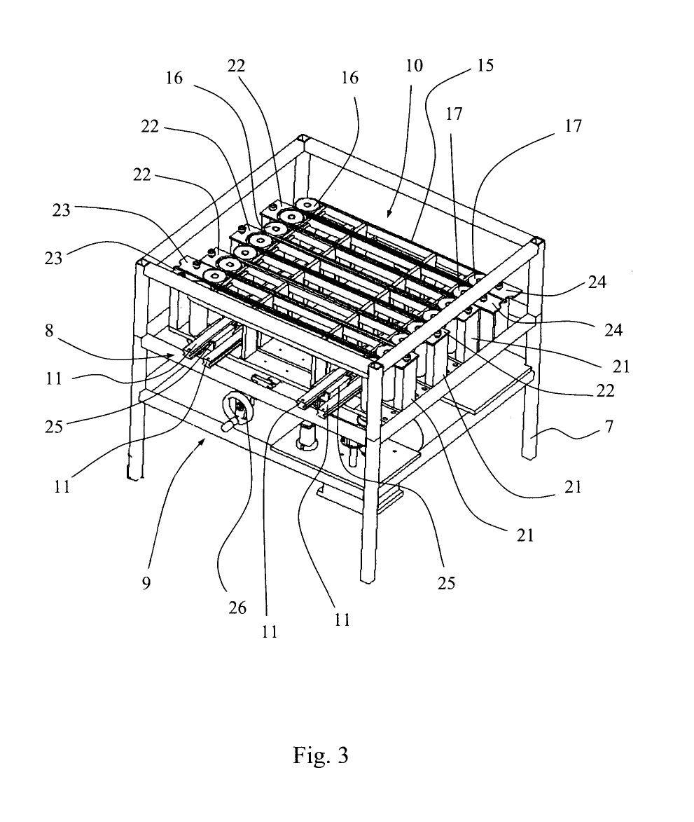

The belt units 10 define a longitudinal direction perpendicular to the transversal direction and comprise endless belts 15 (visible in FIG. 3), each of which are driven by respective pairs of pulleys, for example flat belt pulleys 16, 17, which are in turn driven by a motor unit of a known type, and thus not illustrated.

The belt units 10 are arranged in sequence from a first position to a last position along the transversal direction and are mutually parallel. A track for guiding and transferring pharmaceutical/medical devices, for example syringes, advantageously pre-filled syringes, not illustrated comprises rectilinear parts along the longitudinal direction defined by the cooperation of adjacent belt units 10 and bent parts defined by the cooperation of the belt units 10 and end plates 22 (visible in FIG. 3). In practice, the track has a serpentine-shape and allows the syringes to be moved from the first station 3 to the second station 6. The end plates 22 have a curved profile with determined bend radius. The belt units 10 comprise a support element, for example a base plate 18, arranged along the longitudinal direction, on which there are connected the flat belt pulleys 16, 17, belt spacers 19 for keeping the belt 15 spaced apart and belt support plates 20 for supporting the belt 15.

Moreover, the belt units 10, depending on their position along the transversal direction, further comprise one or two end plate support elements 21, connected to end portions of the base plate 20, for supporting the end plates 22, inlet end plates 23, or outlet end plates 24 (all visible in FIG. 3). It is clear from FIG. 3 that the belt units 10 arranged in first and second position comprise end plate support elements 21 with associated inlet end plates 23 arranged on a same side, while belt units 10 arranged in last and second-last position comprise end plate support elements 21 with associated outlet end plates 24 arranged on a same side. The end plate support elements 21 of the first and second belt units 10 can be arranged on opposite sides (as illustrated) or on the same side of the last and second-last belt units 10. The inlet end plates 23 and the outlet end plates 24 cooperate with the entry adjustable link up conveyor 2 and the exit adjustable link up conveyor 5, respectively, for entering the syringes into the guiding and transferring device 4 and exiting the syringes therefrom, respectively.

Moreover, both the belt units 10 in second and second-last position further comprise second end plate support elements 21 for supporting end plates 22. Belt units 10 arranged in positions between the second and the second-last position comprise one end plate support element 21 each for supporting end plates 22, alternatively disposed on opposite sides.

In practice, the arrangement of the end plate support elements 21 and the end plates 22 associated with all of the belt units 10 enables to obtain a serpentine-shaped track for the syringes.

In detail, the base plate 18 of each belt unit 10 is connected to one of the upper nut 13 of the lead screw 12 and to two movable blocks 25 of the guide rails 11. In operation, two adjacent endless belts 15 are set at a distance or gap depending on syringe dimensions, avoiding the syringes to fall or to get stuck within the endless belts 15. In practice, when syringes are fed to the guiding and transferring device 4 through the entry adjustable link up conveyor 2, a flange of the syringes leans on edges of two adjacent endless belt 15 and the syringe is supported and guided towards the exit adjustable link up conveyor 6.

By operating the lead screw 12, for example manually by means of a crank 26, it is possible to move the belt units 10 along the transversal direction and adjusting the gap between two adjacent belt units 10 in order to accommodate syringes of different dimensions. In general, when syringes of different dimensions are processed, end plates 22 with different bend radius are needed. Accordingly, appropriate end plates 22 are coupled to the end plate support elements 21.

In order to maintain the same gap between each pair of two adjacent belt unit 10, the lead screw 12 with variable pitch is adapted to move each belt unit 10 by a different quantity depending on the position of the specific belt unit 10. The present invention has been illustrated with reference to a specific embodiment, but modifications are possible without departing from the scope of the invention.

In an alternative embodiment, for example, two or more lead screws 12 may be used to drive the belt units 10. Moreover, a different number of guide rails 11 can be used.

1. A guiding and transferring device (4) for guiding and transferring pharmaceutical devices comprising:
a frame (7);
a plurality of conveyor devices (10) defining a longitudinal direction;
a guide device (8) supported on the frame (7) and adapted to guide the conveyor devices along a transversal direction perpendicular to the longitudinal direction; the guiding and transferring device (4) further comprising an adjustment device (9) coupled to the conveyor devices (10) and adapted to adjust a gap between two adjacent conveyor devices along the transversal direction.

2. A guiding and transferring device (4) according to claim 1, wherein the conveyor devices (10) are mutually arranged along the longitudinal direction so as to form a track for the pharmaceutical devices, the guiding and transferring device (4) further comprising end plates (22) adapted to cooperate with the conveyor devices (10) in order to define bent parts of said track.

3. A guiding and transferring device (4) according to any one of claims 1 and 2, wherein the adjustment device (9) is adapted to move at least one of the conveyor devices (10) along the transversal direction.

4. A guiding and transferring device (4) according to any one of claims 1 and 2, wherein the adjustment device (9) comprises a lead screw (12).

5. A guiding and transferring device (4) according to claim 4, wherein said lead screw (12) is of variable pitch type.
